(19) United States
(12) Patent Application Publication
(10) Pub. No.: US 2009/0089111 A1
(43) Pub. Date: Apr. 2, 2009

(54) SYSTEM AND METHOD FOR AUTOMATING PRODUCT LIFE CYCLE MANAGEMENT

(75) Inventors: John O. Walker, Rochester, NY (US); Philip C. Rose, Sodus, NY (US); Barry G. Gombert, Rochester, NY (US)

Correspondence Address: Xerox Corporation (CDFS), 445 Broad Hollow Rd.-Suite 420, Melville, NY, 11747, US

(73) Assignee: Xerox Corporation.

(21) Appl. No.: 11/863,223

(22) Filed: Sep. 27, 2007

(51) Int. Cl. G06Q 10/00; G06F 17/30; G06Q 30/00; G06F 17/40

(52) U.S. Cl. 705/7

(57) ABSTRACT

A system and method to automate product life cycle management is disclosed. Product registration is automated by providing a package with automatic identification and data capture (AIDC) media, such as an RFID tag or a barcode, and a point-of-sale terminal that writes a unique product registration key to the AIDC media. Information about the product and customer is maintained by the brand owner's product management system. A global directory service acting as a broker is used as an intermediary to facilitate interactions between point-of-sale or post sale systems and the brand owner's system. Upon product purchase, customer and unique product identifier is sent to the brand owner's product management system via the broker. The brand owner's system creates a unique product registration key that is sent back to the point of sale terminal, which then writes the unique product registration key to the AIDC media annexed to the product. When the product returned to a store, the AIDC media is scanned, the unique product registration key is extracted, and sent to the brand owner's system for decoding, verification and for product life cycle management. The disclosed system and method ensures that retailers or other unauthorized entities cannot track the product thus alleviating privacy concerns.

### BACKGROUND

The present disclosure relates to the field of business and consumer economics, and more particularly, to a system and method for automating product life cycle management to enable a brand owner to efficiently and effectively track and manage its products.

The life cycle of a product refers to the succession of stages through which a product typically passes during the course of its existence. Such product life cycle stages include, for example, manufacturing, distribution, sales, delivery, use, repair, maintenance, support and disposal. It is often advantageous for a brand owner to keep track of, and manage, its products as they move through the life cycle, and to correlate product data with customer data, such as customer identity, demographics, usage and service history. In this manner, a brand owner can better understand the marketplace in which it competes, provide improved levels of customer service, generate increased customer satisfaction and customer loyalty, and ultimately, achieve greater success.

Brand owners have customarily sought to obtain post-sale customer data through such mechanisms as product registration cards, customer satisfaction surveys, and rebate offers. However, such efforts are often unfruitful. For example, a customer may simply discard a product registration card, or resist filling out a survey, for any number of reasons including indifference, inconvenience, or due to privacy concerns. Rebates, with their promise of economic reward, might be expected to achieve higher compliance rates than voluntary response cards. However, rebate response rates rarely, if ever, approach the ideal because despite monetary incentives, consumers often fail to submit the required rebate documentation.

Product life cycle management can also benefit the brand owner in the unfortunate event of a product recall. By having in advance an accurate and complete database of customers who have purchased its products, a brand owner can rapidly notify its customers of a product recall, demonstrate its preparedness as an enterprise to deal with contingencies that affect the well-being of its customers, and thereby potentially reduce or limit its exposure to liability arising from incidents involving the recalled product.

Brand owners are increasingly concerned with combating the proliferation of counterfeit goods entering the marketplace. No longer the sole province of street vendors, counterfeit goods have found their way into ordinarily legitimate distribution channels.

The ability to identify and prevent the sale of counterfeit goods would therefore greatly assist in the enforcement and protection of a brand owner's intellectual property rights.

Automatic Identification and Data Capture, also known as AIDC, refers to the method of automatically identifying objects, collecting data about them, and entering that data directly into computer systems with minimal, or no, human involvement. AIDC technologies include barcodes, and radio frequency identification (RFID). An AIDC device is a device for reading, and/or writing, data encoded in AIDC media, such as a barcode scanner for reading data encoded in a barcode, or an RFID interrogator for reading and/or writing data encoded in an RFID tag.

Barcodes are machine-readable optical codes for automatic identification characterized by having patterns of image areas exhibiting different light reflective or light absorptive properties into which information is encoded. Barcodes are typically printed using conventional printing means such as offset lithography, inkjet, dot matrix, or xerographic printing processes in accordance with industry standards, such as UPC, Code 39, or PDF-417. Devices for extracting data from barcodes are often referred to as barcode scanners, and are widely used as data-entry devices to input information encoded within a barcode into a computing device.

RFID is another method for automatic identification which uses radiofrequency (RF) signals. A device known as an RFID interrogator wirelessly reads, and optionally, writes, data stored in a transponder, known as an RFID tag, that is physically attached to an article, such as a product, packaging, or shipping container. Typically, an RFID tag consists of two main components: an integrated circuit (IC) for storing and processing data and for modulating and demodulating the RF signal, and an antenna coupled to the chip that enables the chip to exchange data between the tag and interrogator. An RFID tag can be read-only, wherein the IC contains unalterable data, such as a unique identification code indelibly encoded by the tag manufacturer which is used to uniquely identify the tag. Alternatively, an RFID tag can be read-write, wherein the stored data can be changed or deleted. Typically, however, a read-write RFID tag will also contain read-only data, such as an indelible unique identification code, so that individual tags can be uniquely identified.

RFID tags ordinarily range in sizes from several inches to sizes no larger than a grain of rice. RFID tags can be constructed using an essentially planar form factor and incorporated into a self-adhesive label, for example. It is expected the ability to print RFID tags, much like a barcode is printed, will eventually become widespread using, for example, techniques developed by Xerox for depositing liquid polythiophene semiconductors onto a surface at room temperature.

Consumers and watchdog groups have expressed concerns that the unscrupulous or illicit use of RFID technology represents a threat to privacy. For example, an unauthorized third party can read an RFID tag using an illegitimate RFID interrogator, or by intercepting RF signals transmitted between the tag and a legitimate RFID interrogator. Privacy concerns are also raised where a predator organization seeks to read the RFID tags of its competitors' products to harvest product and consumer information stored in those RFID tags.

What is needed, therefore, is a better means of performing product life cycle management in which the collection and maintenance of product, consumer, and transaction data is enhanced, while the privacy of consumers and legitimate organizational users is protected.

### SUMMARY

The present disclosure is directed to a system and method of product life cycle management which facilitates product registration. The term “point-of-sale terminal” as used herein encompasses any apparatus, such as a cash register, computer, computer terminal, handheld device, etc., which performs a sales transaction for any purpose. The term “post-sale terminal” as used herein encompasses any apparatus, such as a cash register, computer, computer terminal, handheld device, etc., which performs a post-sales transaction, such as a return, exchange, repair, service or disposal, for any purpose. A point-of-sale terminal can also be a post-sale terminal, and vice versa.

Disclosed is an automated product life cycle management system which includes a point-of-sale system, and additionally, a post-sale system; an intermediary global directory service system; and at least one brand owner product management system. The systems are operably connected via data communications means, such as the Internet.

According to the present disclosure, the brand owner assigns a unique product identification code (UPID) to each instance of a product to be tracked by the disclosed automated product life cycle management system. As an example only, brand owner X wishes to track product Y, and has an order to ship 100 units of Y. Each of the 100 units, or product instances, is assigned its own UPID. In an embodiment, the UPID is a unique read-only code contained within an RFID tag that is annexed to the product instance. Additionally or alternatively, the UPID is encoded with a barcode annexed to the product instance. In an embodiment, the UPIDs are stored in the product life cycle management system, for example, in a database.

Once the brand owner has assigned a UPID to each product instance it wishes to track, the UPIDs are transmitted to the global directory service, where they are stored, for example, in a database, and where the UPIDs are associated with the brand owner. In an embodiment, each UPID is associated with a network address of the brand owner's product life cycle management system, for example, the URL of the brand owner's product life cycle management system.

At the point of sale, a point-of-sale terminal having an AIDC device, such as a barcode scanner and/or an RFID interrogator, is used to read the UPID from the barcode, the read-only RFID tag, or the read-write RFID tag, that is annexed to the product being purchased. The point-of-sale system additionally collects information about the customer, such as name, address, phone number, from the credit or debit card transaction, a scanned bank check, or via oral or written means and manually entered into the point-of-sale system by the sales clerk. The point-of-sale terminal transmits the UPID to the global point of sale broker system, which then determines the brand owner product management life cycle system address associated with the UPID, and transmits this address back to the point-of-sale system.

The point of sale system then transmits the UPID and customer information to the brand owner product management life cycle system, which stores the customer information in association with the UPID, in, for example, a database. In an embodiment, the product management life cycle system generates a unique product registration key (UPRK) which is also stored in association with the customer information and/or the UPID. The product management life cycle system then transmits to the point-of-sale system an acknowledgement, and optionally, the UPRK. Upon receipt of the acknowledgement, the point-of-sale system completes the sales transaction. If a UPRK was received, it is provided to the customer. In an embodiment, the UPRK is written to a read-write RFID tag attached to the purchased product by the RFID interrogator. It is also contemplated the UPRK may be printed in barcode and/or human readable form on a customer receipt; printed on a label which is thereafter annexed to the purchased product by, for example, the sales clerk; or by other suitable means such as an automated marking device or automated labeling device.

The product instance is thus associated with the customer within the brand owner's system. However, because the barcode or RFID tag contains no personal or organizational information that may be used outside of the brand owner's system, the customer's and the brand owner's information privacy is protected. Moreover, improved product life cycle management is thus facilitated since the brand owner is now able to associate subsequent product transactions with the customer, and with the individual product instance, with attendant benefits accruing to the brand owner and to the customer.

For example, the customer experience is enhanced by eliminating the paperwork customarily required for product registration, rebate redemption, warranty registration and providing proof of purchase. Inconveniences typically encountered by the customer when interacting with post sale services, such as product repair, product return, and obtaining replacement parts, are reduced. The customer receives the benefit of automatic product registration without action on the customer's part. The brand owner's system, by providing secure information, ensures that the retailer or other entity cannot track this product thus alleviating customer privacy concerns.

From the brand owner's perspective, product life cycle management is enhanced because post-sale information is automatically collected. This provides brand owners with the ability to better target high-value customers using special promotions, to improve and optimize products by enabling better customer feedback, to reduce costs by eliminating or reducing retail paperwork for product returns including writing product return data to the RFID tag, and to facilitate product recalls. Quality control can more closely be monitored because, for example, problems endemic to specific production batches can be quickly identified and monitored.

In an embodiment, the present disclosure provides a means to identify and prevent the sale of counterfeit products by preventing the completion of a sales transaction where, for example, the RFID tag contains invalid or unrecognized data, or if no RFID tag is annexed to the product as expected. For example, if either the broker or the brand owner system does not recognize the RFID product identifier, a denial message is transmitted to the point-of-sale or post-sale system which, for example, blocks the sales transaction, prevents a product return, or denies repair service. Additionally or alternatively, the broker or brand owner system transmits a counterfeit detection notification to brand owner personnel, who may then take appropriate action.

Also contemplated within the scope of the present disclosure is a means to track and trace products that are subject to controlled distribution, such as pharmaceuticals, illicit drug precursor chemicals, weapons, explosives, nuclear material, and hazardous industrial substances.

In an embodiment, the global directory service is a global point-of-sale web service that brokers between the point-of-sale and/or the post-sale system, and the brand owner's system. The global point of sale web service provide a secure global directory service that stores the relationships between unique product codes and the brand owner's product management system address. In an embodiment, the brand owner's product management system address can be a uniform resource locator (URL) or an IP address. Upon product purchase, the unique product identifier code is sent from the point-of-sale system to the broker using a secure communication protocol, using, for example, HTTPS, SSL, SSH or other suitable protocol. Additionally or alternatively, the identity of the point-of-sale system and/or the broker is authenticated during the communication session. Using the unique product identifier code, the broker determines the brand owner's product management system address and transmits the address to the point-of-sale system. In an embodiment, the relationship between the product identifier code and the brand owner's product management system address is stored in a database. Also envisioned within the scope of the present disclosure is an arrangement whereby the broker charges a fee to the point-of-sale operator, the post-sale operator and/or the brand owner. Such fees can be structured in any number of arrangements, such as a per-transaction fee, flat-rate, tiered fees, or in accordance with any suitable fee arrangement, which may be different with respect to each point-of-sale operator, post-sale operator and/or brand owner participant in the system.

Having obtained the brand owner's product management system address, the point-of-sale system transmits the unique product identifier and customer information to the brand owner's product management system using a secure communication protocol, using, for example, HTTPS, SSL, SSH or other suitable protocol. Additionally or alternatively, the identity of the point-of-sale system and/or the brand owner's product management system is authenticated during the communication session. In response, the brand owner's product management system creates a unique product registration key that is transmitted back to the point-of-sale terminal, which causes the RFID interrogator to write the unique product registration key to the product's RFID tag.

Considering now the scenario where the customer returns a product for a post-sale interaction, such as a return or warranty repair, when the product is presented at the post-sale terminal. The RFID interrogator reads the RFID tag at the post-sale terminal, the unique product identifier is extracted, and is transmitted to the broker. From the unique product identifier, the broker determines the brand owner's product management system address, which is transmitted to the post-sale system. Subsequently, the post-sale system transmits the unique product registration key and a service request to the brand owner's product management system, which determines if the service request is valid with respect to the unique product registration key, and transmits a post-sale validity response to the post-sale system. Upon receipt of the post-sale validity response, the post-sale system will accordingly either permit or deny the requested service. Upon completion of the requested service, the post-sale system transmits a post-sale action performed acknowledgement to the brand owner's product management system, which stores a record of the post-sale action in association with the UPID. Additionally or alternatively, the post-sale system transmits a post-sale action denial acknowledgement which optionally stores a record of the post-sale action denial in association with the UPID.

### BRIEF DESCRIPTION OF THE DRAWINGS

Various embodiments of the present disclosure will be described herein below with reference to the figures wherein:

FIG. 1 is a block diagram of an automated product life cycle management system in accordance with the present disclosure;
FIG. 2A illustrates an exemplary embodiment of a point of sale system in accordance with the present disclosure;

FIG. 2B illustrates an exemplary embodiment of a post-sale system in accordance with the present disclosure;

FIG. 3 illustrates an exemplary embodiment of a global directory service in accordance with the present disclosure;

FIG. 4 illustrates an exemplary embodiment of a brand owner product management system in accordance with the present disclosure;

FIG. 5 illustrates point of sale request processing in accordance with the present disclosure; and

FIG. 6 illustrates post-sale request processing in accordance with the present disclosure.

### DETAILED DESCRIPTION

Embodiments of the presently disclosed automated product life cycle management system and method are described herein in detail with reference to the drawings, in which like reference numerals designate identical or corresponding elements in each of the several views.

Referring to FIG. 1, there is disclosed an automated product life cycle management system 100 comprising at least one point of sale system 200, at least one post-sale system 270, at least one global directory service 300, and at least one brand owner product management system 400. The at least one point of sale system 200, at least one post-sale system 270, at least one global directory service 300, and at least one brand owner product management system 400 are operably interconnected by data network 105. In an embodiment, data network 105 is a public network, such as the Internet.

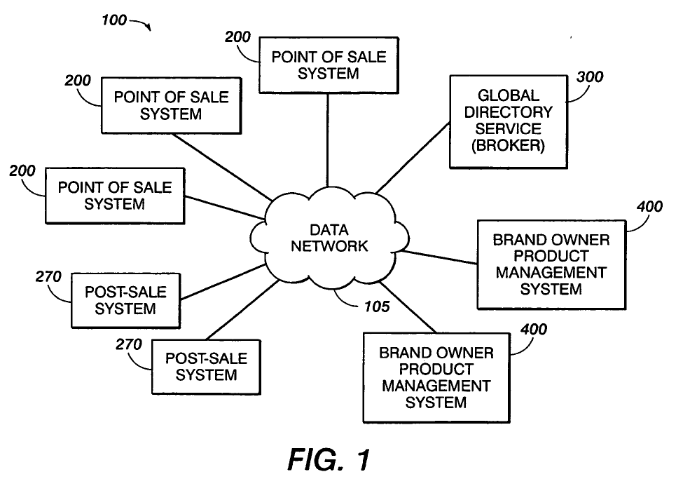

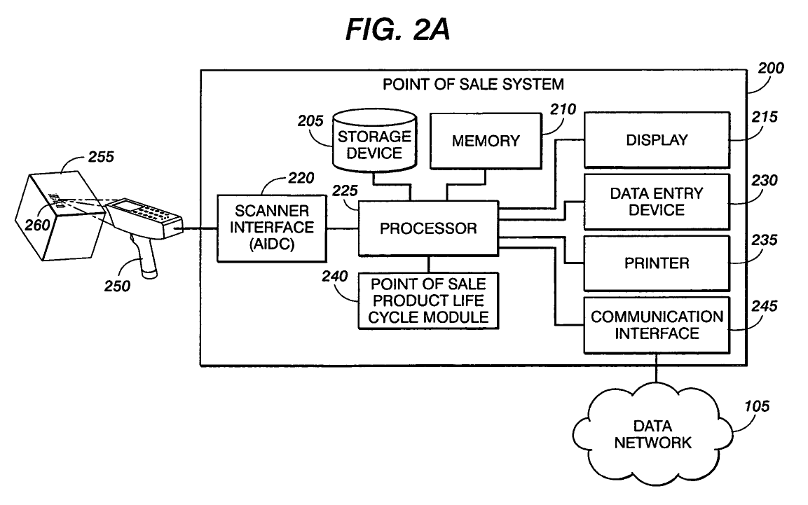

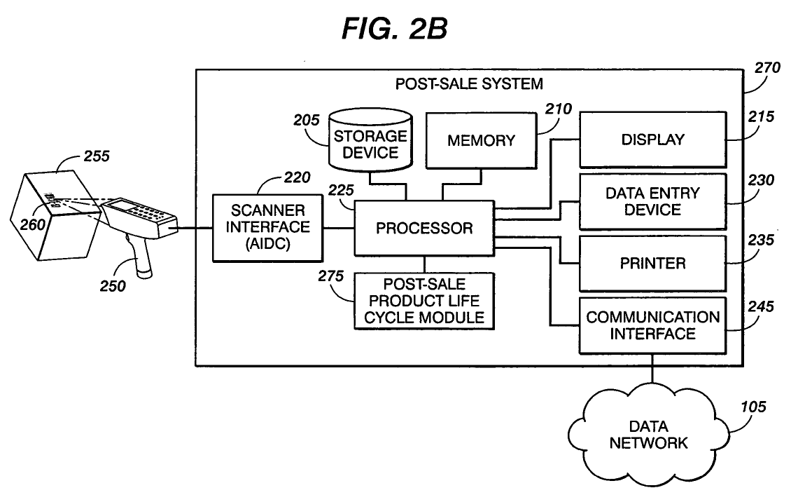

In FIGS. 2A and 2B, a point of sale system is designated generally by reference numeral 200, and a post-sale system is designated generally by reference numeral 270, respectively. The exemplary embodiments depicted of point of sale system 200 and post-sale system 270 each have an AIDC device 250 for reading and/or writing AIDC media 260 incorporated within product 255. In an embodiment, AIDC device 250 is an RFID interrogator and AIDC media 260 is a read-only, or alternatively, a read/write RFID tag. The present disclosure also contemplates that AIDC device 250 is a barcode scanner, and AIDC media 260 is a barcode. AIDC device 259 is operatively coupled to processor 225 via AIDC device interface 220, which can be of a wired or a wireless type. Processor 225 is also operatively coupled, by system bus or other suitable means, to display 215, data entry device 230, printer 235, storage device 205, memory 210, and communications interface 245 operatively coupled to data network 105 as will be familiar to the skilled artisan. In an embodiment, communications interface 245 may be a wired network interface such as a 100Base-T Fast Ethernet interface, or a wireless network interface such as a wireless network interface compliant with the IEEE 802.11 standard.

In accordance with the present disclosure, the at least one point of sale system 200 further includes a point of sale product life cycle module 240 having at least one of software, firmware and hardware that includes a set of programmable instructions configured for execution by the at least one processor 225 for performing point of sale life cycle management transactions as disclosed herein. The at least one post-sale system 270 further includes a post-sale product life cycle module 275 having at least one of software, firmware and hardware that includes a set of programmable instructions configured for execution by the at least one processor 225 for performing post-sale life cycle management transactions as disclosed herein.

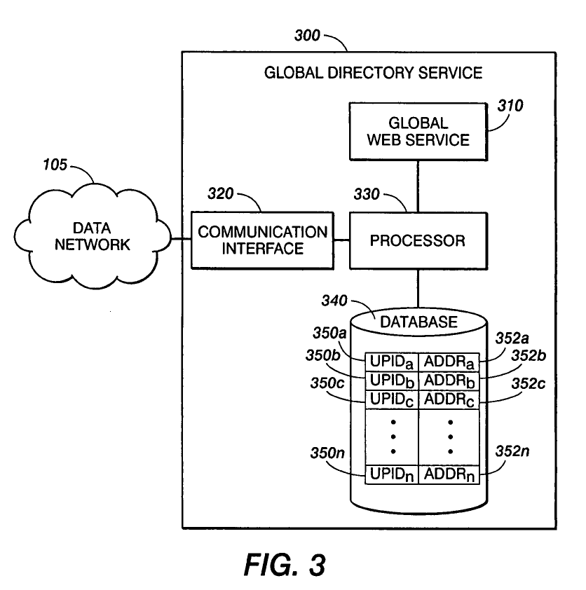

Turning to FIG. 3, there is disclosed an embodiment of global directory service 300 having a processor 330 operatively coupled to data network 105 via communication interface 320, a global web service 310 having at least one of software, firmware and hardware that includes a set of programmable instructions configured for execution by the at least one processor 330 for responding to service requests received from point of sale product life cycle module 240 and/or post-sale product life cycle module 275 in accordance with the present disclosure. Global directory service 300 further includes database 340 for storing relationships between each UPID 350a et seq., and its corresponding brand owner product management system address (ADDR) 352a et seq.

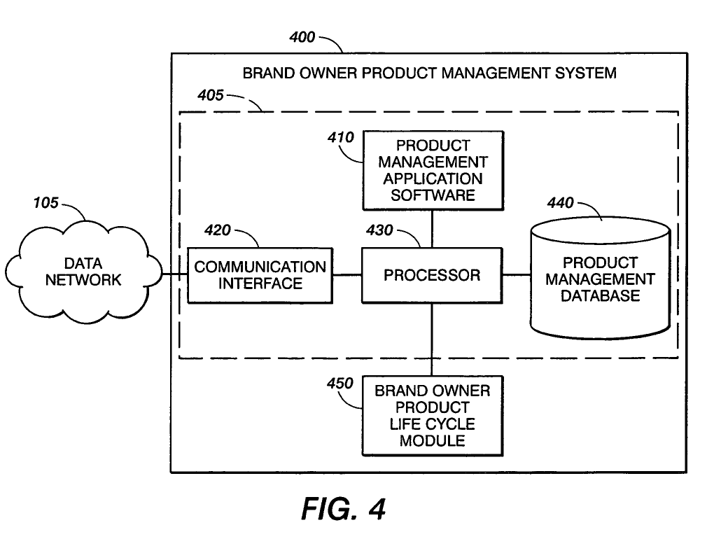

FIG. 4 illustrates a typical brand owner product management system 400 comprising product management application software 410 and product management database 440, a processor 430 operatively coupled to data network 105 via communication interface 420, brand owner product life cycle module 450 having at least one of software, firmware and hardware that includes a set of programmable instructions configured for execution by the at least one processor 430 for responding to point of sale service requests received from point of sale product life cycle module 240, and/or post-sale service requests received from post-sale product life cycle module 275 in accordance with the present disclosure. In an embodiment, brand owner product life cycle module 450 augments a brand owner's existing or legacy product management system 405.

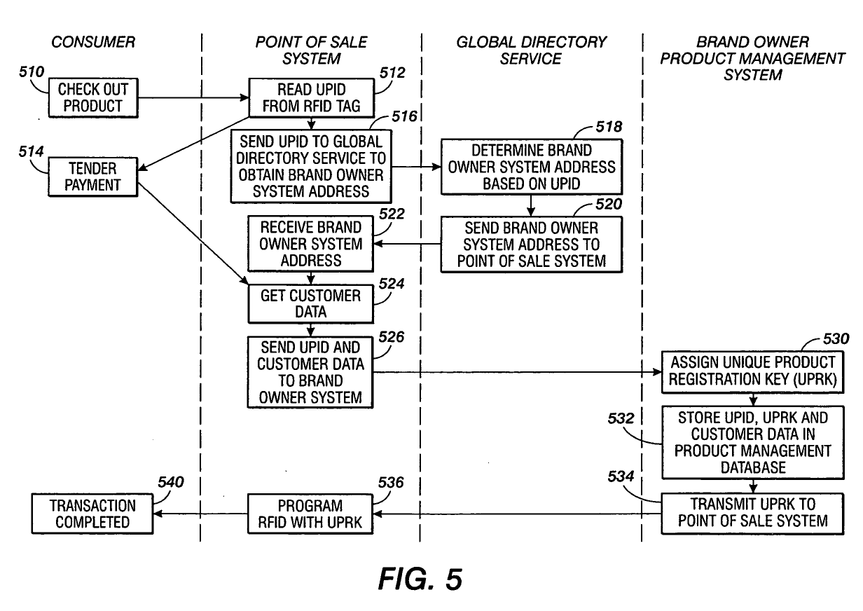

A method of point of sale request processing in accordance with the present disclosure will now be described in detail with reference to FIG. 5, wherein an exemplary interchange between a consumer, the point of sale system, the global directory service and the brand owner product management system is illustrated. In the step 510 the consumer presents to a sales clerk for a purchase transaction product 255 comprising read-write RFID tag 260. RFID interrogator 250 reads the UPID encoded within RFID tag 260 in the step 512 and in the step 516, point of sale product life cycle module 240 causes to be sent a service request containing the UPID to global directory service 300. Upon receipt of the service request, global directory service 300 in the step 518 determines from the UPID the brand owner product management system address in accordance with the relationship stored in database 340 and in the step 520 causes to be sent to point of sale product life cycle module 240 the brand owner product management system address, where it is received in the step 522. Asynchronously to the steps 516 through 522, the consumer tenders payment in the step 514, and in the step 524 customer data is collected in accordance with the present disclosure. In the step 526, point of sale product life cycle module 240 causes to be sent a service request containing the UPID and the customer data to brand owner product life cycle module 450 incorporated within brand owner product management system 400 located at the address received in the step 522. In the step 530, brand owner product life cycle module 450 assigns a UPRK to the transaction, and in the step 532 causes to be stored in product management database 440 a transaction record comprising the UPID, UPRK and customer data. In the step 534, brand owner product life cycle module 450 causes to be sent to point of sale life cycle module 240 the UPRK, which in the step 536 causes RFID interrogator 250 to write the UPRK to RFID tag 260 of product 255, whereafter in the step 540 the point of sale transaction is completed.

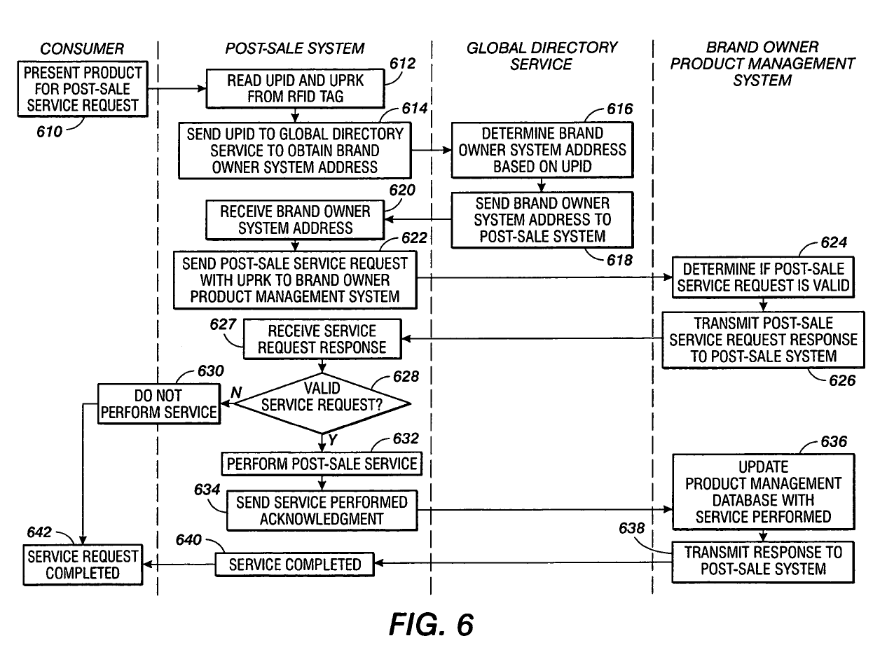

Turning now to FIG. 6, a method of post-sale request processing in accordance with the present disclosure is now described in detail. In the step 610, the consumer presents to a post-sales clerk for a post-sale transaction product 255 comprising RFID tag 260, whereupon in the step 612 RFID interrogator 250 reads the UPID and UPRK stored within RFID tag 260. In the step 614, post-sale product life cycle module 275 causes to be sent a service request containing the UPID to global directory service 300. Upon receipt of the service request, global directory service 300 in the step 616 determines from the UPID the brand owner product management system address in accordance with the relationship stored in database 340 and in the step 618 causes to be sent to post-sale product life cycle module 275 the brand owner product management system address, where it is received in the step 620.

In the step 622, post-sale product life cycle module 275 causes to be sent a post-sale service request containing the UPRK to brand owner product life cycle module 450 incorporated within brand owner product management system 400 located at the address received in the step 620. Subsequently in the step 624, brand owner product life cycle module 450 retrieves the transaction record associated with the UPRK from product management database 440, determines if the requested post-sale service is valid. In the step 626 a post-sale service request response is caused to be sent to post-sale product life cycle module 275, which is received by product life cycle module 275 in the step 627. Optionally, the step 624 further includes recording the attempted invalid post-sale service request in the associated transaction record in product management database 440.

In the step 628, the post-sale service request response is examined. If the requested post-sale service is invalid, the post-sale transaction is denied; optionally, the step 630 is performed wherein the post-sales clerk is notified accordingly by, for example, a visual indication displayed on display 215; and the post-sale transaction is completed in the step 642.

Conversely, if the requested post-sale service is valid, the requested post-sale service is performed in the step 632. As examples only, a post-sale service includes one of a product return for a refund, product return for store credit, defective product exchange, unwanted product exchange, product tendered for warranty service, product tendered for non-warranty service, product service completed, product recycling, and product disposal. In the step 634 a post-sale service performed acknowledgement is caused to be sent by the post-sale product life cycle module to the brand owner product life cycle module, whereupon in the step 636, the associated transaction record in product management database 440 is updated to reflect that the requested post-sale service was successfully performed. In the step 638 a transaction completion response is caused to be sent by the brand owner management system to the post-sale system, which is received in the step 640, and the post-sale transaction is completed in the step 642.

It is contemplated that the steps of the method in accordance with the present disclosure can be performed in a different ordering than the ordering provided herein.

Also disclosed is a computer-readable medium storing a set of programmable instructions configured for being executed by at least one processor for performing a method of automating product life cycle management in accordance with the present disclosure

It will be appreciated that variations of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims. The claims can encompass embodiments in hardware, software, or a combination thereof.

What is claimed is:

1. A method for automating product life cycle management, comprising:
at a point of sale, reading from AIDC media annexed to a product being purchased a unique product identifier;
transmitting to a global directory service the unique product identifier;
receiving from the global directory service a brand owner system address;
collecting customer data corresponding to the purchaser of the product;
transmitting to the brand owner system the unique product identifier and customer data;
receiving from the brand owner system a unique product registration key; and
storing on the AIDC media the unique product registration key.

2. The method according to claim 1, further comprising storing on the brand owner system the unique product identifier, the customer data and the unique product registration key.

3. The method according to claim 1, further comprising:
at a post-sale system, receiving a post-sale request from a customer;
reading from AIDC media annexed to a product corresponding to the post-sale request the unique product identifier and the unique product registration key;
transmitting to a global directory service the unique product identifier;
receiving from the global directory service a brand owner system address;
transmitting to the brand owner system the post-sale service request wherein the post-sale service request includes the unique product registration key;
validating the post-sale service request;
performing the post-sale service request;
transmitting to the brand owner system an acknowledgement that the post-sale service request was performed;
storing the acknowledgement in the brand owner system; and
receiving a response from the brand owner system.

4. The method according to claim 3, wherein the acknowledgement is stored in a database.

5. The method according to claim 3, further comprising:
at the brand owner system, determining whether a post-sale service request is valid;
transmitting to the post-sale system the post-sale service request validity determination;
at the post-sale system, receiving the post-sale service request validity determination; and
prohibiting the post-sale service if the post-sale service request is invalid.

6. The method according to claim 1, wherein the AIDC media is an RFID tag.

7. The method according to claim 6, wherein the RFID tag is annexed to the product corresponding to the post-sale request by depositing liquid polythiophene semiconductor material onto the product.

8. The method according to claim 1, wherein the AIDC media is a barcode.

9. The method according to claim 8, wherein the barcode is printed by xerographic means.

10. The method according to claim 8, wherein the AIDC media containing the unique product registration key is annexed to the product being purchased.

11. The method according to claim 1, further comprising causing to be stored within the global directory service at least one unique product identifier and a corresponding brand owner product management system address.

12. A system for automating product life cycle management comprising:
at least one point of sale system comprising at least one AIDC device and a point of sale life cycle module;
at least one post-sale system comprising at least one AIDC device and a post-sale product life cycle module;
at least one brand owner product management system comprising a brand owner product life cycle module; and
at least one global directory service comprising a database for storing the relation between at least one unique product identifier and a corresponding product management system address.

13. The system according to claim 12, wherein the point of sale life cycle module is configured to:
obtain a unique product identifier from AIDC media annexed to a product being purchased;
obtain customer data associated with the purchaser of the product;
obtain a unique product registration key; and
write the unique product registration key to AIDC media annexed to the product being purchased.

14. The system according to claim 12, wherein the post-sale life cycle module is configured to:
obtain a unique product identifier and a unique product registration key from AIDC media annexed to a product tendered in connection with a post-sale service request;
cause to be sent the unique product registration key and the post-sale service request to the brand owner product management system.

15. The system according to claim 12, wherein the brand owner product life cycle module is configured to:
receive from the point of sale system a unique product identifier and customer data;
generate a unique product registration key upon receipt of a unique product identifier and customer data from the one point of sale system;
transmit the unique product registration key to the point of sale system;
cause to be stored the relation between the unique product identifier, the customer data, and the unique product registration key.

16. The system according to claim 12, wherein the brand owner product life cycle module is configured to:
receive from the post-sale system a post-sale service request comprising a unique product registration key;
determine whether the post-sale service request is valid;
transmit to the post-sale system the post-sale service request validity determination;
receive from the post-sale system a post-sale service request completion acknowledgement; and
cause to be stored the post-sale service request completion acknowledgement in relation to the corresponding unique product registration key.

17. The system according to claim 12, wherein the brand owner product life cycle module is configured to authenticate the identity of the point of sale system.

18. The system according to claim 12, wherein the brand owner product life cycle module is configured to authenticate the identity of the post-sale system.

19. The system according to claim 12, wherein the global directory service is configured to:
receive a unique product identifier from a requesting system;
determine a brand owner product management system address corresponding to the unique product identifier; and
transmit the brand owner product management system address to the requesting system.

20. The system according to claim 19, wherein the requesting system is a point of sale system.

21. The system according to claim 19, wherein the requesting system is a post-sale system.

22. The system according to claim 12, wherein the global directory service is configured to authenticate the identity of the requesting system.

23. A computer-readable medium storing a set of programmable instructions configured for being executed by at least one processor for performing a method for automating product life cycle management, comprising:
at a point of sale, reading from AIDC media annexed to a product being purchased a unique product identifier;
transmitting to a global directory service the unique product identifier;
receiving from the global directory service a brand owner system address;
collecting customer data corresponding to the purchaser of the product;
transmitting to the brand owner system the unique product identifier and customer data;
receiving from the brand owner system a unique product registration key; and
storing on AIDC media the unique product registration key.

24. The computer-readable medium according to claim 23, wherein the method for automating product life cycle management further comprises:
at a post-sale system, receiving a post-sale request from a customer;
reading from AIDC media annexed to a product corresponding to the post-sale request the unique product identifier and the unique product registration key;
transmitting to a global directory service the unique product identifier;
receiving from the global directory service a brand owner system address;
transmitting to the brand owner system the post-sale service request wherein the post-sale service request includes the unique product registration key;
validating the post-sale service request;
performing the post-sale service request;
transmitting to the brand owner system an acknowledgement that the post-sale service request was performed;
storing the acknowledgement in the brand owner system; and
receiving a response from the brand owner system.
